(19) United States
(12) Patent Application Publication
(10) Pub. No.: US 2019/0125503 A1
(43) Pub. Date: May 2, 2019

(54) Method For Producing A Dental Restoration

(71) Applicant: Ivoclar Vivadent AG, Schaan (LI)

(72) Inventors: Sebastian Krolikowski, Lachen (CH); Markus Rampf, Lachen (CH)

(21) Appl. No.: 16/094,284

(22) PCT Filed: Feb. 22, 2017
(86) PCT No.: PCT/EP2017/054100

§ 371 Date: Oct. 17, 2018

(30) Foreign Application Priority Data
Apr. 22, 2016 (EP) 16166705.0

(51) Int. Cl. A61C 13/08; A61C 13/00; B28B 1/00; B33Y 10/00; B33Y 70/00; B33Y 80/00

(52) U.S. Cl. CPC A61C 13/082; A61C 13/081; A61C 13/0022; A61C 13/0019; A61C 13/083; B28B 1/001; B33Y 10/00; B33Y 70/00; B33Y 80/00; A61C 13/0013

(57) ABSTRACT

The invention relates to a method for producing a dental restoration, in which method a blank is made available which is made from ceramic, in particular glass ceramic, or glass and which has a predefined spatial dependency of the material property color and/or opacity in its volume, and the blank (105) is pressed into a press chamber of a press muffle (20) and, in this way, material of the blank is pressed, through a channel structure issuing from the press chamber, into a mold cavity (212) corresponding to the dental restoration, wherein the channel structure (214) and the spatial dependency of color and/or opacity in the blank (105) are coordinated with each other, such that one of a plurality of possible distributions of color and/or opacity is obtained in the ceramic material of the dental restoration (106) formed in the mold cavity (212), characterized in that
the basic spatial dependency of color and/or opacity and/or of optical structural features (98) in the blank (105) is determined from a desired distribution of color and/or opacity and/or of optical structural features in the dental restoration to be produced, taking account of the flow paths in the channel structure,
the blank (105) is made available by being built up individually in an additive method with the determined spatial dependency of color and/or opacity and/or of optical structural features (98).

The present invention relates to a method for producing a dental restoration, in which method a blank is made available which is made from ceramic, in particular glass ceramic, or glass and which has a predefined spatial dependency of the material property color and/or opacity in its volume, and the blank is pressed into a press chamber of a press muffle and, in this way, material of the blank is pressed, through a channel structure issuing from the press chamber, into a mold cavity corresponding to the dental restoration, wherein the channel structure and the spatial dependency of color and/or opacity in the blank are coordinated with each other, such that one of a plurality of possible distributions of color and/or opacity is obtained in the ceramic material of the dental restoration formed in the mold cavity. The invention further relates to the use of a blank which is made from ceramic, in particular glass ceramic, or glass and which is built up individually in a layer-by-layer additive method with a determined spatial dependency of color and/or opacity in its volume, wherein the determined spatial dependency of color and/or opacity in the volume of the blank has been determined such that, by pressing the blank through the channel structure into a cavity, corresponding to the dental restoration, of a press muffle, the desired distribution of color and/or opacity and of desired structural features in the dental restoration to be produced is obtained in the material pressed into the cavity.

Methods by which dental restorations can be produced from ceramic material in an “automated” manner using CAD-CAM systems have already been known for some time. After a digital image has been taken (scanning in the mouth of the patient or on an impression model), the dental restoration can be milled or ground from solid material using a milling machine, on the basis of the scan data. However, these subtractive production methods also have disadvantages, e.g. a large part of the valuable glass materials or glass ceramic materials used is lost. In addition, the machines used are expensive and require considerable maintenance.

In addition to the subtractive methods, so-called additive methods are also used, which are also known by the expressions “rapid prototyping” or “generative manufacture”. Examples of these are stereolithography, 3D powder printing and 3D inkjet printing. Certain additive methods are based on the layer-by-layer build-up of a three-dimensional shaped body, wherein the two-dimensional layers are built up on one another with in each case a predefined contour.

In addition, pressing or molding methods are also known for the production of dental restorations. In these methods, a model of the dental restoration to be produced, which model consists of a material that can be burned out completely, is mounted on a negative mold of the channel structure forming a later channel structure (also designed as sprue pin system) made from such material inside a press muffle, wherein the end of the negative mold pointing away from the mold cavity is secured on a projection on the floor of the press muffle. Thereafter, the press muffle is filled with an embedding compound, such that the model of the dental restoration and the negative mold of the channel structure are completely surrounded by the embedding compound. The embedding compound is cured to form a refractory press mold, and the model and the negative mold of the channel structure are burned out in order to generate, in the cured press mold, a (complementary) mold cavity corresponding to the model of the dental restoration and the open channel structure leading to the mold cavity. The floor of the press muffle is removed, after which a receiving chamber or press chamber remains in the press mold at the site of the projection, from which chamber the channel structure leads to the mold cavity. A blank, e.g. made of ceramic and having a shape largely complementing the press chamber, is inserted into the press chamber and, using pressure and in most cases heat, is pressed such that ceramic material of the blank is pressed through the channel structure into the mold cavity in order to completely fill the mold cavity and thus produce the dental restoration in the desired shape. A method of this kind, which works according to the described principle of the expendable mold, is known from EP 2 952 154 A1, for example.

Moreover, EP 2 233 449 B1 discloses a method according to the preamble of claim 1, which method likewise works according to the expendable mold principle. In this method, ceramic blanks are used whose volumes are subdivided into two or more volume areas that differ in terms of the material property color and/or opacity. At the transition from one volume area to another one, the material property color and/or opacity must not change abruptly, and instead it can form a gradual transition. An example is a cylindrical blank which is subdivided into halves along a plane containing the longitudinal axis of the cylinder, wherein the material in one half differs in terms of its color from the one in the other half. In the channel structure leading from the press chamber, into which the blank is inserted, to the mold cavity, one or more channels are formed with such configurations (bifurcating blind channels or widenings or hollows) resulting in different flow times from the press chamber to the mold cavity for the resulting flow paths. The channel structure and the spatial dependency of the material property color and/or opacity in the blank are coordinated in such a way that one of a plurality of possible color or opacity distributions is obtained in the material in the mold cavity when the latter is filled with material from the blank. For the known pressing methods, a range of standard blanks is made available, these blanks having a number of predefined and different distributions of color and/or opacity in their volume, such that, depending on the blank selected from the range, one of a plurality of possible color or opacity distributions is obtained in the dental restoration.

With pressing methods of this kind, it is possible to produce dental restorations with a profile adapted approximately to a desired color or opacity profile in one pressing step. However, in these methods, the customer is reliant on a range of prefabricated standard blanks, each with a defined spatially dependent opacity and color profile, from which range it is then necessary to select the one best suited to the desired profile in the the dental restoration. By individual configuration of the geometry of the channel structure, the profile of the flow processes can be adapted to a certain extent to the desired distribution of the material properties (color and/or opacity) in a desired direction, but an exact adaptation to a desired distribution of color and/or opacity is not possible. In addition to the limited nature of the range of standard blanks, it is also not possible for the customer to reproduce optional fine structural features, e.g. enamel fissures, mamelons, enamel spots, etc., of a human tooth in the dental restoration to be produced. If a dental restoration is to be individualized to this extent, the dental technician has to carry out additional and time-consuming finishing steps, e.g. the so-called cut-back technique, in which surface areas of the dental restoration are removed again and new layers with different optical properties are formed in the areas from which material has been removed.

The disadvantages of the lack of individualization of the press-molded dental restorations are generally tackled by performing subsequent steps such as painting or the aforementioned cut-back technique and subsequent build-up of layers with a ceramic layering compound. In addition to the large amount of time involved, the application of layers in particular has a crucial disadvantage. While the press blank is made of high-strength glass ceramic (e.g. lithium disilicate) with a strength of >360 MPa, conventional layering compounds for lithium disilicate consist of fluorapatite or feldspar glass ceramics with a strength of approximately 100 MPa. On account of the lower strength of the layers applied from such layering compounds, the strength for stressed areas such as incisal edges is greatly reduced, which can lead to early failure of the dental restoration.

It is an object of the present invention to make available a method for producing dental restorations, by which method it is possible for optical structural features to be individually formed, in an improved and simpler way, in the dental restoration that is to be produced.

This object is achieved by the method with the features of claim 1. Advantageous embodiments of the method are set forth in the dependent claims. A use of an individually produced blank in a pressing method for producing a dental restoration is defined in claim 9. Claim 10 defines a kit for producing an individual blank for a pressing method for a dental restoration.

According to the present invention, provision is made that, from a desired distribution of color and/or opacity and if appropriate of optical structural features (enamel fissures, mamelons, enamel spots, etc.) in the dental restoration to be produced, taking account of the flow paths in the channel structure, the basic spatial distribution of color and/or opacity in the blank is determined from which the desired distribution results after the pressing of the blank to form the dental restoration. This blank is then made available by being built up individually in an additive method with the determined spatial distribution of color and/or opacity for the dental restoration to be produced in this case. The determination of the required spatially dependent distribution of color and/or opacity can be effected by reverse imaging of the flow processes in the pressing process, e.g. by simulation, such that the desired spatial distribution of color and/or opacity in the dental restoration is reproduced in the spatial distribution of color and/or opacity in the blank that generates the dental restoration.

Thus, according to the invention, for a dental restoration to be produced from a blank by a pressing method, an individually adapted blank is produced by an additive, generative method, the color and opacity distribution of which blank is specifically coordinated such that, after the pressing into the mold cavity, the desired spatial dependency of color and/or opacity and the optionally desired structural features are obtained there. In addition to the general color and opacity profile, the layer-by-layer build-up of the blank permits the introduction of additional structural elements (e.g. mamelons, enamel fissures, enamel spots, etc.), which are positioned precisely in the produced dental restoration by virtue of the high degree of spatial fidelity in the pressing process.

In contrast to the situation in EP 2 233 449 B1 mentioned above, the method of the present invention does not require the use of an individually adapted channel structure which also in a standard channel structure by complete individualization of the distribution of the material properties in the blank each desired distribution of the material properties (color and/or opacity and/or optical structural features) can be produced in the press-molded dental restoration.

Where the present application refers to a blank made from ceramic, in particular glass ceramic, or from glass, this is not intended to exclude the possibility that the blank can also contain binder at least before the pressing process. Moreover, the formulation of ceramic, in particular glass ceramic, or glass is of course not intended to exclude the possibility that further constituents such as dyes can be contained in the blank. Moreover, the blank does not need to have the end properties of the adapted restoration, i.e. it does not have to be dense-sintered and instead can be porous; it can also have other strengths and/or other crystalline phases. On the other hand, however, it is also possible that the blank is already sintered or pre-sintered.

In a preferred embodiment, the blank is heated before or during the pressing. On the one hand, heating (hot pressing) is in any case preferable in order to improve the flowability of the material in the pressing process. In the case of blanks that have been produced by additive methods using binders, the heating serves at the same time to remove binder and pre-sinter the blank. Binders are used, for example, in 3D powder printing and in 3D inkjet printing, wherein the color and opacity in the blank is selectively controlled by inking the binder or by separately printed color. After removal of the binder, the desired color and opacity profile is retained. In this way, it is possible for the blank, directly after it has been built up, to be inserted without further intermediate steps into the press chamber of the press muffle and heated, and for the dental restoration to be produced by pressing into the mold cavity. Further intermediate steps such as separate removal of binder or pre-sintering are not necessary.

By means of the pressing process, the material of the dental restoration (e.g. lithium disilicate) acquires a very high precision fit and the same mechanical properties as conventionally press-molded lithium disilicate. The advantage of producing a blank using an additive method lies in the complete individualization of the blank and in the adaptation to the desired color and opacity profiles in the dental restoration produced. The build-up process of the blank, e.g. by 3D powder printing or by 3D inkjet printing, is very quick and simple, since the geometry of the blank can be simple; it is possible, for example, to use cylindrical or cubic blanks which can be built up very easily and quickly. Individually colored binders can be printed in the 3D powder print or 3D inkjet print. On account of the simple geometry of the blanks, the build-up processes with a 3D powder layer print or a 3D inkjet print can be carried out very quickly and without high demands on the spatial resolution, which at the same time keeps down the equipment costs for the additive production of the blanks.

An individual configuration of the blank is possible here, e.g. a desired layer sequence of more translucent/more opaque layers, wherein color and/or opacity can also vary across the surface of a layer by means of spatially resolved printing processes. By virtue of the high degree of fidelity of layers and spatial fidelity in the pressing process, it is also possible for structures such as mamelons, enamel fissures and enamel defects to be defined spatially selectively in the blank, such that the structure in the dental restoration is positioned at the desired location. The blank is in this case configured spatially in the X, Y and Z directions in these 3 dimensions with a desired spatial distribution of color and/or opacity and/or structural features. The Z direction, i.e. the longitudinal axis of the blank, in the direction of which the blank is pressed, is particularly important here for the opacity profile or an enamel fissure as structural feature.

By means of the press-molding of the blank that has been built up in layers, the material acquires the end geometry dental restoration (with very high accuracy) and its end properties as in conventional pressing processes.

In a preferred embodiment, glass with seeds is used for building up the blank.

In an alternative embodiment, the blank is built up using a glass ceramic with the main crystal phase lithium metasilicate, lithium disilicate or SiO₂ phases or intermediates thereof. Such materials are described, for example, in WO 2015/173 394 A1.

The individually required spatial dependency of color and/or opacity in a blank can be determined, for example, by the desired distribution of color and/or opacity and of optical structural features in the dental restoration to be produced being subjected to a chronologically backward simulation of the flow processes during the pressing of the material through the channel structure into the mold cavity, in order thereby to obtain, in the blank, the spatial dependency of color and/or opacity which, after the material has been pressed into the mold cavity, provides there the desired distribution of color and/or opacity. The simulation of the flow processes during the flow of the material, when the latter is pressed through the channel structure and into the mold cavity, is possible with a high degree of accuracy and can be converted into a chronologically backward simulation which then carries the desired spatial dependency of color and/or opacity and of structural features in the finished dental restoration over to the spatial dependency, producing said structural features during the pressing process, in the blank for the pressing method. The simulation of the filling process through the channel structure can be effected by fluid mechanic calculations, for example by a statistical approach based on particles or on a grid model (finite element method). The performance of such flow simulations are known and available for many materials and are in some cases part of commercial software.

For the layered build-up of the blank, 3D powder printing and 3D inkjet printing methods are particularly suitable. In 3D powder printing methods, a printer with two troughs is used, each of the troughs having a trough bottom with a pressure piston. One of the troughs is filled with the powder for the build-up method, while the second trough alongside this one likewise has a height-adjustable trough bottom. The printing of the object begins by lowering the trough bottom of the second trough by one layer thickness, after which, by means of an applicator arm transporting powder from the first trough to the second trough, the first layer of powder is applied to the trough bottom of the second trough. This is now bound, in the forms desired for the layer, using a printer with an ink jet that can be dyed selectively via pigments, particles or binders and, by selective control of the color of the ink jet, is provided spatially dependently with color and bound. The ink could be a liquid or a carrier with pigments, with coloring ions/salts, or even a slip.

Thereafter, the trough bottom of the second trough lowers again, and a new layer of powder is applied and then bound and colored in a spatially selective manner by the printer. After the printing and binding of the last layer, the unbound powder surrounding the built-up body is removed, such that the desired shaped body remains. In 3D inkjet printing methods, the building material (ceramic or glass particles) is printed in a spatially selective manner with the selectively colored binder, wherein the printer heads work in principle like inkjet printer heads. A 3D inkjet printing method of this kind is described, for example, in EP 2 783 837 A1.

In addition to the fact that a separate binder removal and sintering step is not needed, it is also possible to use simpler binder systems, since sintering is not required and, therefore, the green density is not important.

Moreover, it is possible to use spherical glass beads, e.g. with diameters in the range of 20 μm to 100 μm, as a result of which better flowability and low binder fractions are possible. The meterability is improved by the spherical shape of the glass beads. The size of the glass beads determines the resolution precision and the demands placed on the equipment. The larger the glass beads, the lower the resolution, i.e. the lower the detail accuracy of the built-up shaped body. In addition to glass beads, however, it is also possible in principle to use glass powder, granules, etc.

Moreover, the blank adapted individually to the dental restoration to be produced also allows the amount of blank material to be exactly adapted such that exactly enough material is made available for the dental restoration to be produced, which permits material savings in relation to standardized blanks.

As has been mentioned above, it is possible to use blanks with simple geometries (circular cylinder, square, triangular cylinder, or cylinder with hexagonal base surface, etc.). However, particularly if the spatially dependent distribution of color and/or opacity and/or structural features in the blank is not rotationally symmetrical, it is preferable that the blanks are provided with an anti-twist means, e.g. with a projection at a location on their circumference. The press chamber of the press muffle is then provided with a corresponding complementary recess, such that the blank can be inserted into the press chamber in only one predefined position of rotation. This ensures that the corresponding distribution of color and/or opacity obtained in the blank by back-simulation of the distribution of color and/or opacity desired in the dental restoration also lies so positioned in the press chamber that, during the pressing and flowing of the material through the channel structure, the desired flow process is obtained that specifically provides the desired distribution of color and/or opacity in the press-molded dental restoration.

According to a further aspect, the present invention relates to the use of a blank which is made from ceramic, in particular glass ceramic, or from glass and which has a predefined spatial dependency of the material property color and/or opacity in its volume, for producing a dental restoration, for which purpose the blank is pressed into a press chamber of a press muffle and, in this way, material of the blank is pressed, through a channel structure issuing from the press chamber, into a mold cavity corresponding to the dental restoration, wherein the channel structure and the spatial dependency of color and/or opacity in the blank are coordinated with each other, such that a desired distribution of color and/or opacity is approximately obtained in the ceramic material of the dental restoration formed in the mold cavity, characterized in that the blank is built up individually in a layer-by-layer additive method with a determined spatial dependency of color and/or opacity in its volume, wherein the determined spatial dependency of color and/or opacity in the blank is determined from a desired distribution of color and/or opacity and of optical structural features in the dental restoration to be produced, taking account of the flow paths in the channel structure by reverse imaging in the the basic spatial dependency of color and/or opacity in the blank.

According to a further aspect, the present invention relates to a kit for use in a method for producing a dental restoration, in which method a blank is made available which is made from ceramic, in particular glass ceramic, or glass and which has a predefined spatial dependency of the material property color and/or opacity in its volume, and the blank is pressed into a press chamber of a press muffle and, in this way, material of the blank is pressed, through a channel structure issuing from the press chamber, into a mold cavity corresponding to the dental restoration, wherein the channel structure and the spatial dependency of color and/or opacity in the blank are coordinated with each other, such that a desired distribution of color and/or opacity is approximately obtained in the ceramic material of the dental restoration formed in the mold cavity, characterized in that the kit has:

raw material of ceramic, in particular glass ceramic, or glass,
a build-up device for the generative build-up of a three-dimensional shaped body made from the raw material, and
a computer program which, when executed in a data processor, is configured to
determine, from a desired distribution of color and/or opacity and/or of optical structural features in the dental restoration to be produced, taking account of the flow paths in the channel structure, the basic spatial dependency of color and/or opacity in the blank, and
control the build-up device such that the blank is made available by being built up individually in an additive method with the determined spatial dependency of color and/or opacity and/or optical structural features.

The invention is described below on the basis of an illustrative embodiment in the drawings, in which:

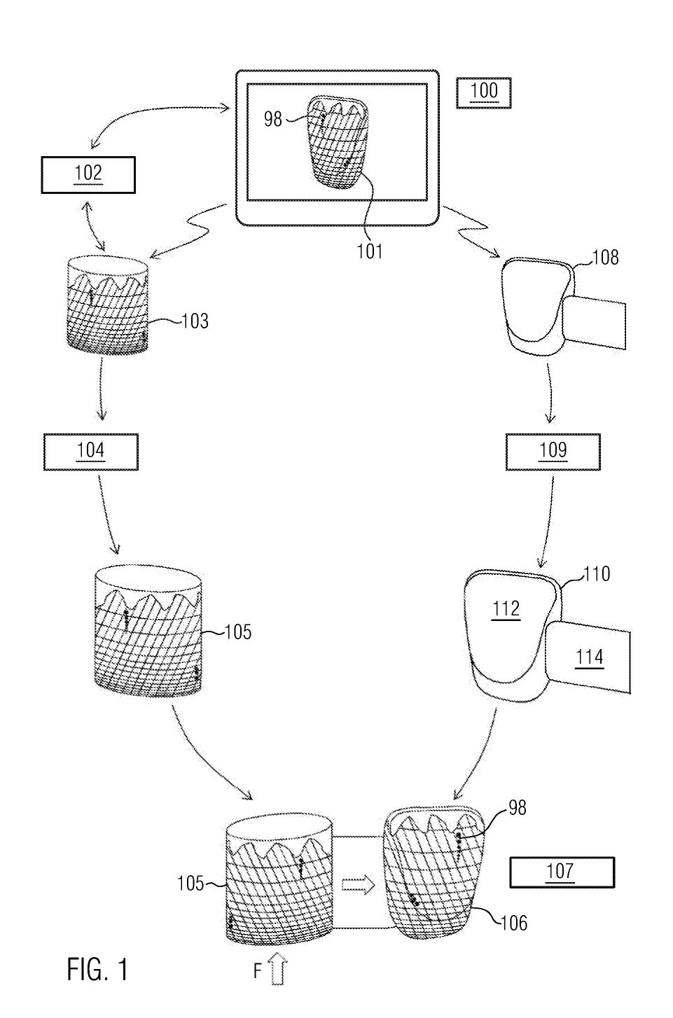

FIG. 1 shows a diagram, similar to a flow chart, depicting the sequence of the method according to the invention,

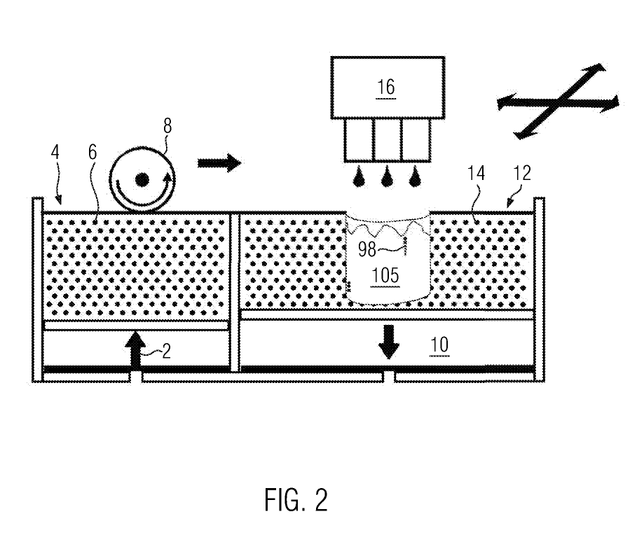

FIG. 2 shows a cross-sectional view of a printing device for 3D powder printing that can be used in connection with the method according to the invention,

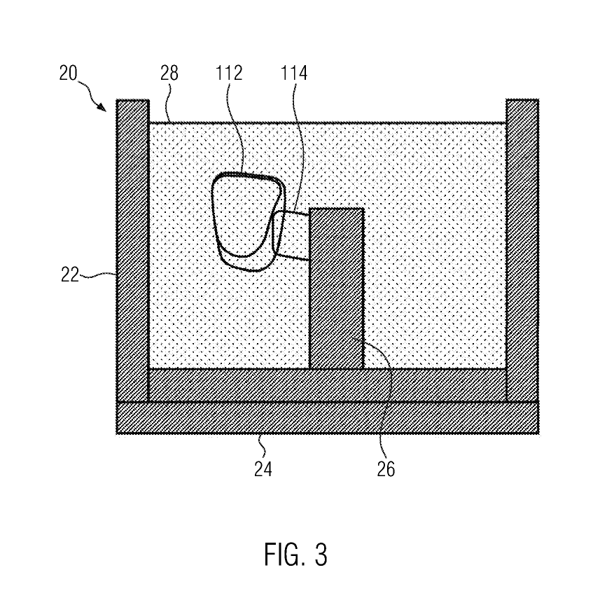

FIG. 3 shows a schematic cross-sectional view of a press muffle in which a model for a mold cavity of the dental restoration and for a channel structure is arranged and surrounded by an embedding compound in the interior of the press muffle,

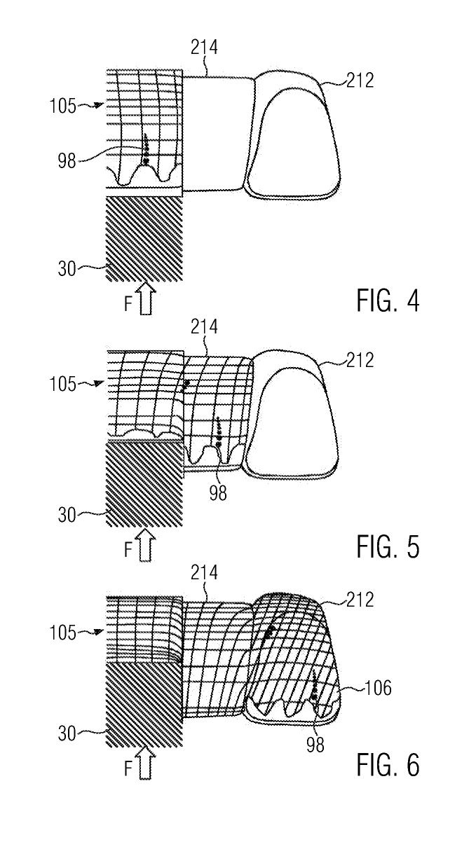

FIGS. 4 to 6 show schematic cross-sectional views of successive states during the pressing of the blank out of a press chamber and into the channel structure and the mold cavity.

The production of the press mold is first of all explained in brief, said press mold being needed for the pressing method that is employed in the method according to the present invention. A press muffle is designated in general by 20 and comprises a press muffle sleeve 22 and a press muffle base 24, which is connected releasably to the press muffle sleeve 22. A projection 26 is secured centrally on an attachment piece on the press muffle base 24 and protrudes into the interior of the press muffle sleeve 22. The projection 26 serves for the mounting of the model of the channel structure 114 and of the model 112 of the dental restoration adjoining the latter. The model 114 for the channel structure, which model is otherwise also designated as a sprue pin system, and the model 112 for the mold cavity are composed of a material that can be burned out completely, for example wax or plastic. The model 112, for the dental restoration to be produced, and the associated channel structure 114 have been created in advance on the basis of a 3D data model for the dental restoration to be produced, wherein this can be carried out using additive methods such as 3D powder printing or 3D inkjet printing, by subtractive methods such as milling, or by manual fabrication. After the model 114 for the channel structure and the model 112 for the dental restoration have been mounted on the projection 26 in the interior of the press muffle sleeve 42, the latter is filled completely with an embedding compound. The embedding compound can have a gypsum-like, phosphate-bound composition, comprising for example silica flour, and is initially flowable and cures to form the press mold 28 after introduction into the press muffle. After the curing, the press muffle base 24 can be released from the press muffle sleeve 22 and removed with the projection 26 secured thereon. After the materials of the model 112 for the dental restoration and of the model 114 for the channel structure have burned out, cavities matching the models remain in the press mold 28. In the area of the removed projection 26, a press chamber remains which, at the end lying in the embedding compound, is connected to the hollow channel structure. A blank made from ceramic or glass can be inserted into the press chamber and is then pressed by a pressure piston into the interior of the press chamber, as a result of which material of the blank is pressed through the channel structure 114 into the mold cavity and is there press-molded in order to form the dental restoration with a shape like the shape of the model 112 for the dental restoration.

As is described in EP 2 065 012 B1, a blank with partial areas of different color and/or opacity can be used for the pressing, wherein the distribution of color/opacity in the pressed state in the mold cavity and thus in the produced dental restoration is determined by the distribution of color/opacity in the blank and by the flow processes through the channel structure and into the mold cavity. However, in the method described in EP 2 065 012 B1, only some standard blanks with certain variations in the distributions of color/opacity were used, and a certain variation including the desired result was effected by adapting the geometry of the channel structure (in order to influence the flow processes). In connection with the present invention, an individual adaptation of the channel structure is not necessary.

The method according to the present invention is now first of all explained with reference to FIG. 1. With the aid of a data processor 100, a 3D data model 101 of the desired dental restoration is generated in a known manner, said model being shown in FIG. 1 on a screen arranged alongside the data processor 100.

The 3D data model 101 of the dental restoration is provided with grid lines, of which the density varies across the volume of the dental restoration. This is intended to provide a schematic indication of a spatially dependent distribution of color and/or opacity in the volume of the dental restoration. At the top of the 3D data model 101, mamelons are indicated on the incisal edge. Moreover, the 3D data model 101 contains further structural features, such as enamel spots 98. After the 3D data model of the dental restoration has been completed, a process is carried out in step 102 involving a reverse imaging from the 3D data model 101 of the dental restoration to a 3D data model 103 of the blank, which process, taking account the flow processes during the pressing of the blank according to this 3D data model in the channel structure and into the mold cavity, provides a distribution of color and/or opacity and structural features in the generated dental restoration corresponding to the 3D data model 101 of the desired dental restoration. Such reverse mapping from the desired product with the design of the 3D data model 101 of the dental restoration to the corresponding distribution of color and/or opacity and structural features to the 3D data model 103 of the blank, which is intended to be used as starting product in the pressing process, can be obtained by simulating the flow processes of the material through the channel structure and into the mold cavity until the latter is completely filled, e.g. by varying the distribution in the 3D data model 103 of the blank until the distribution of color and/or opacity and structural features, resulting after simulating the pressing process, in the simulated result of the pressing process coincides with the 3D data model 101 of the desired dental restoration. Such simulations of flow processes and corresponding variation of the starting distribution of color and/or opacity, such that a desired distribution is obtained after the flow process, are known to a person skilled in the art. Directly reverse imaging by reverse flow simulation from the desired 3D data model of the dental restoration to a corresponding 3D data model 103 of the blank is also possible by [symbol] .

The physical blank 105 corresponding to the 3D data model 103 of the blank, and having the desired distribution of color and/or opacity and/or structural features, is then built up in step 104 by a layer-by-layer additive, generative construction method in order to obtain the physical blank 105.

Along with the production of the individualized blank 105, the right-hand branch of the process, starting from the data processor 100, entails the production of a model with which, in accordance with the principle of the expendable mold, an insert mold is intended to be generated for the pressing process for the dental restoration. Firstly, a 3D data model 108 is generated for the shape of the mold cavity for the dental restoration and for the channel structure adjoining the latter. In step 109, a corresponding physical model 110 with a physical model 112 for the dental restoration and with an adjoining model 114 for the channel structure is then generated from the 3D data model 108 in a production method. This model 110 is produced from a material that can be burned out completely, such as wax or plexiglass. There are no limitations on the production method in step 109; for example, it is possible to use CAM methods which, from the 3D data model 108, generated the physical model 110 by generative additive methods or subtractive methods (milling), which physical model 110, as explained in connection with FIG. 3, is then introduced into the interior of the press muffle sleeve 22 and encapsulated there by embedding compound, in order finally to obtain the cured insert mold 28, which then has the desired cavity structure after the model 110 is burnt out. The individualized blank 105 is then inserted into the press chamber generated by the projection 26 in the press mold 28. By pressing the individualized blank 105 into the press chamber, material of the blank is pressed through the channel structure, adjoining the press chamber, and into the mold cavity of the dental restoration in the press mold. This procedure is shown only schematically in step 107 at the bottom of FIG. 1. Since the physical blank 105, in the method according to the invention as described above, has been produced individually and adapted individually to the dental restoration to be produced and to the desired distribution of color and/or opacity and/or structural features by reverse imaging of the pressing process, after the pressing process the physical dental restoration 106 with the shape and distribution of color and/or opacity and/or structural features as predefined by the 3D data model 101 for the dental restoration is obtained, i.e. the physical dental restoration 106 has the spatial distribution of color, opacity and structural features as predefined by the 3D data model 101 (the physical dental prosthesis 106 is shown from the other side in FIG. 1 in relation to the 3D data model of the dental prosthesis).

The pressing process is shown in somewhat greater detail in the sequence of FIGS. 4 to 6. In FIG. 4, the blank 105 is located in the press chamber of the press mold (not shown). In the starting state shown in FIG. 4, in which the blank 105 is located in the press chamber, the channel structure 214 is still completely empty. Force is now applied to the blank 105 using a pressure piston 30, which force presses the blank 105 into the press chamber. Since the channel structure 214 in this case forms the only space in which material can escape, the pressing process, which is preferably preceded by a heating of the blank 105, presses material of the blank 105 into the channel structure 214, as is shown in FIG. 5. After further pressing by the piston 30, the mold cavity 212 for the dental restoration is finally completely filled and the material of the dental restoration therein is press-molded. In the illustrative embodiment shown, the press chamber is adjoined only by one channel structure and one mold cavity. In principle, it is also possible for two or more channel structures to issue from the press chamber and each lead to an associated mold cavity, if several dental restorations are intended to be pressed simultaneously in parallel. In the case of two or more channel structures with associated mold cavities, all of these of course have to be taken into account in the simulation of the flow processes and in the reverse imaging of the dental restorations that are to be obtained on a blank that generates them.

As is indicated in FIGS. 4 to 6 by the distortion of the grid lines and by the migration of the structural features 98, the distribution of color and/or opacity, as indicated by the grid lines in the blank 105, and the position of fine structures 98 is transformed in the pressing process into a changed grid structure and a changed positon of the fine structures 98 in the dental restoration 106. According to the present invention, the blank 105 with its distribution of color and/or opacity and/or structural features is built up individually, specifically such that, after the transformation by the pressing process, dental restoration 16 is obtained with a distribution of color and/or opacity and/or structural features 98 as is predefined by the basic 3D data model 101 of the dental restoration. In other words, in the reverse imaging indicated schematically in step 102 of FIG. 1, a transformation was carried out by simulation by which a 3D data model of the desired prosthesis from the state in FIG. 6 is converted, by reversing the flow processes in the pressing process, into a corresponding 3D data model for the blank 105 in the state in FIG. 4.

To illustrate the individualized build-up process for the individualized blank 105 from the 3D data model 103 for the blank, reference is made for example to the illustration of a 3D powder printing method in FIG. 2. FIG. 2 shows a first trough containing powder 6. With a transport roller 8, powder 6 is transported into an adjacent second trough 12 and, in the form of a layer, onto a blank 105 that is to be built up there. After each application of a new layer of powder, an inkjet print head 16, controlled in the X and Y directions, is moved across the surface of the build-up area, as a result of which the applied layer of powder is imprinted and bound with binder with spatially predefined colors or absorbing substances to generate more light-impermeable areas. Binders and colors can also be imprinted separately from each other. After printing of a layer, the lifting device 10 under the second trough 12 is lowered by a distance corresponding to a layer height, the first trough 4 is correspondingly lifted by a first lifting device 2, and fresh power 6 is applied once again by the transport roller 8 onto the last layer formed on the blank 105. This process is repeated until the desired blank 105 has been produced completely. Thereafter, remaining powder 14 not printed with binder is removed and recycled, such that the desired blank 105 that has been built up individually is available for further processing.

1. A method for producing a dental restoration comprising
providing a blank having a predefined spatial dependency of material properties comprising color and/or opacity,
pressing the blank (105) through a channel structure into a mold cavity (212) corresponding to the dental restoration,
wherein the channel structure (214) and the spatial dependency of color and/or opacity in the blank (105) are coordinated such that one of a plurality of possible distributions of color and/or opacity is obtained in the dental restoration (106) formed in the mold cavity (212),
wherein the spatial dependency of color and/or opacity and/or of optical structural features (98) in the blank (105) is determined from a desired distribution of color and/or opacity and/or of optical structural features in the dental restoration to be produced, taking account of the flow paths in the channel structure,
wherein the blank (105) is made by being built up individually in an additive method with a determined spatial dependency of color and/or opacity and/or of optical structural features (98).

2. The method as claimed in claim 1,
wherein the blank is heated before and/or during the pressing.

3. The method as claimed in claim 1,
wherein the blank (105), after it has been built up, is inserted without any further intermediate steps directly into a press chamber of a press muffle, in order to produce a dental restoration (106).

4. The method as claimed in claim 1,
wherein the built-up blank (105) is pre-sintered or dense-sintered before being introduced into a press chamber.

5. The method as claimed in claim 1,
wherein the blank (105) is built up by a stereolithography, 3D powder printing or 3D inkjet printing method.

6. The method as claimed in claim 1,
wherein glass with seeds is used for building up the blank (105).

7. The method as claimed claim 1,
wherein the blank (105) is built up using a glass ceramic with a main crystal phase comprising lithium metasilicate, lithium disilicate or SiO₂ phases or intermediates thereof.

8. The method as claimed in claim 1, wherein required spatial dependency of color and/or opacity and/or optical structural features (98) in the blank is determined by the desired distribution of color and/or opacity and of optical structural features in the dental restoration to be produced being subjected to a chronologically backward simulation of the flow processes during the pressing of the material through the channel structure (214) into the mold cavity (212), in order thereby to obtain, in the blank, the spatial dependency of color and/or opacity which, after the material has been pressed into the mold cavity (212), provides there the desired distribution of color and/or opacity and/or of optical structural features (98).

9. A blank comprising a predefined spatial dependency of the material property color and/or opacity for producing a dental restoration, for which purpose the blank (105) is pressed into a press chamber of a press muffle (20) and, in this way, material of the blank is pressed, through a channel structure (214) issuing from the press chamber, into a mold cavity (212) corresponding to the dental restoration, wherein the channel structure and the spatial dependency of color and/or opacity in the blank are coordinated with each other, such that one of a plurality of possible distributions of color and/or opacity is obtained in the dental restoration formed in the mold cavity,
wherein the blank is built up individually in a layer-by-layer additive method with a determined spatial dependency of color and/or opacity and/or of optical structural features (98) in a volume,
wherein the determined spatial dependency of color and/or opacity and/or of optical structural features (98) in the blank (105) is determined from a desired distribution of color and/or opacity and/or of optical structural features (98) in the dental restoration to be produced, taking account of the flow paths in the channel structure by reverse mapping to the the basic spatial dependency of color and/or opacity and/or of optical structural features (98) in the blank.

10. A kit for use in a method for producing a dental restoration, comprising:
raw material of ceramic, glass ceramic, or glass,
a build-up device (2, 4, 8, 10, 12, 16) for the generative build-up of a three-dimensional shaped body made from the raw material, and
a computer program which, when executed in a data processor (100), is configured to
determine, from a desired distribution of color and/or opacity and/or of optical structural features in the dental restoration to be produced, taking account of flow paths in a channel structure (214) of a pressing device, the basic spatial dependency of color and/or opacity and/or of optical structural features (98) in the blank (105),
control the build-up device (2, 4, 8, 10, 12, 16) such that the blank (105) is made by being built up individually in an additive method with a determined spatial dependency of color and/or opacity and/or optical structural features (98).

11. The method as claimed in claim 1,
wherein the blank is fabricated of ceramic, glass ceramic or glass.

12. The blank as claimed in claim 9,
wherein the blank is fabricated of ceramic, glass ceramic or glass.
